(19) United States
(12) Patent Application Publication
(10) Pub. No.: US 2017/0364692 A1
(43) Pub. Date: Dec. 21, 2017

(54) ELECTRONIC FILE SHARING LINK GRANULARITY

(71) Applicant: Microsoft Technology Licensing, LLC, Redmond, WA (US)

(72) Inventors: Rafael Lopez-Uricoechea, Seattle, WA (US); Eugene S. Lin, Seattle, WA (US)

(21) Appl. No.: 15/183,313

(22) Filed: Jun. 15, 2016

(51) Int. Cl. G06F 21/62; G06F 17/30; G06F 17/22; H04L 29/06; G06F 3/0484

(52) U.S. Cl. CPC G06F 21/6209; H04L 63/105; G06F 3/0484; G06F 17/2235; G06F 17/30589

(57) ABSTRACT

An electronic file sharing system includes a data store, a processor, and memory. The memory is coupled to the processor and stores instructions that when executed by the processor, provide electronic file storage relative to the data store. The processor is configured to detect a first sharing operation from a first entity to share a selected electronic file with a second entity to allow the second entity to interact with the selected electronic file in a way set by the first entity. The processor is further configured to generate a first sharing link for the second entity to access the selected electronic file in the way set by the first entity. The processor is also configured to detect a second sharing operation from an entity other than the first entity to share the selected electronic file with a third entity in the way set by the first entity and to generate a second sharing link for the third entity to access the selected electronic file in the way set by the first entity. The first sharing link is different than the second sharing link.

### BACKGROUND

Storage of electronic files, such as documents, photos, spreadsheets, presentations, videos, songs, and more is virtually a necessity in modern times. Centralized storage of and access to such files in a network-accessible manner allows the files to be accessed and maintained easily and effectively from a variety of network-connected devices. One form of such storage is in online storage platform that is accessible over the internet and allows users and/or organizations to create accounts with the online storage provider in order to securely upload, access, edit, and delete such electronic files.

One way in which electronic files are shared with multiple users is by providing a user to whom an electronic file will be shared with a link, such as a Uniform Resource Locator (URL) that relates not only to an online storage provider, but also to a particular file. Further, such links may differ based on file access rights, such as a first link being provided to allow users to have read access to a file, while a second link is provided to allow users to have read/write access to a file. However, as online sharing of electronic files becomes more ubiquitous, limitations of current systems become more pronounced.

The discussion above is merely provided for general background information and is not intended to be used as an aid in determining the scope of the claimed subject matter.

### SUMMARY

An electronic file sharing system includes a data store, a processor, and memory. The memory is coupled to the processor and stores instructions that when executed by the processor, provide electronic file storage relative to the data store. The processor is configured to detect a first sharing operation from a first entity to share a selected electronic file with a second entity to allow the second entity to interact with the selected electronic file in a way set by the first entity. The processor is further configured to generate a first sharing link for the second entity to access the selected electronic file in the way set by the first entity. The processor is also configured to detect a second sharing operation from an entity other than the first entity to share the selected electronic file with a third entity in the way set by the first entity and to generate a second sharing link for the third entity to access the selected electronic file in the way set by the first entity. The first sharing link is different than the second sharing link.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a network-accessible data storage system with which embodiments described herein are particularly useful.

FIG. 2 is a diagrammatic view of an electronic file being shared among multiple users with different access rights.

FIG. 3 is a diagrammatic view of an electronic file being shared with multiple users in accordance with an embodiment described herein.

FIG. 4 is a diagrammatic view of a link store in accordance with one embodiment.

FIG. 5 is a flow diagram of a method of generating a sharing link for an electronic file in accordance with one embodiment.

FIG. 6 is a general block diagram of components of a client device that can run components of the data storage system shown in FIG. 1 to interact with the data storage system.

FIGS. 7 and 8 are diagrammatic views of client devices that can run components of the data storage system to interact with the data storage system.

FIG. 9 is a general block diagram of a computing device that can run components of a data access system or client device that interacts with the data access system, or both.

### DETAILED DESCRIPTION

While embodiments described herein generally have a wide applicability to any electronic system that is able to store electronic files and allow multiple users to selectively access such electronic files, the remainder of this description will be described with respect to an online data storage system that is accessible over the internet. This embodiment is considered a cloud computing embodiment.

Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of the architecture as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installation and repairs, etc.

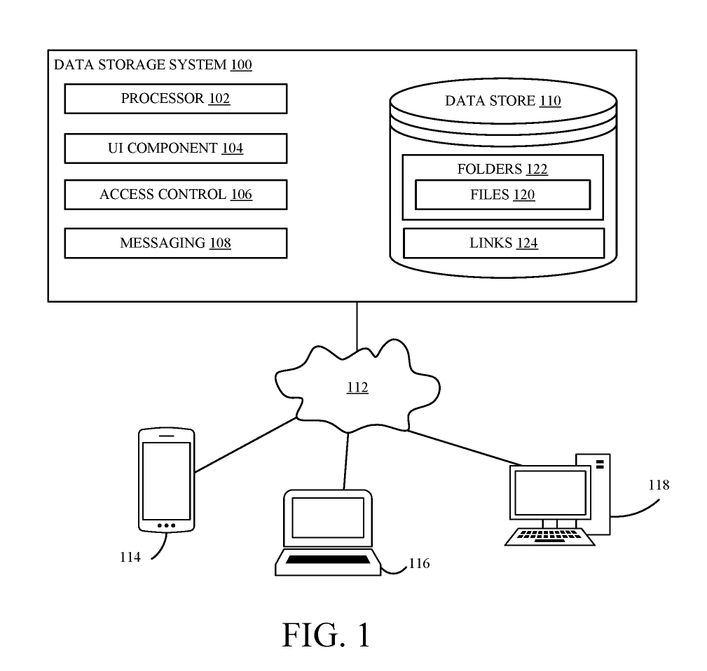

FIG. 1 is a diagrammatic view of an online data storage system with which embodiments described herein are particularly useful. Data storage system 100 includes processor 102, user interface (UI) component 104, access control component 106, messaging component 108, and data store 110. Additionally, while not specifically shown in FIG. 1, data storage system 100 includes suitable circuitry or other arrangements to enable data storage system 100 to connect to network 112 in order to provide access to devices 114, 116, and 118. While network 112 may be any suitable network, such as a local area network, embodiments described herein are particularly applicable when network 112 is a wide area network, such as the internet.

Processor 102 is illustratively a computer processor that has associated memory and timing circuitry, not separately shown. Processor 102 is illustratively a functional part of data storage system 100 and facilitates the functionality of data storage system 100 in providing access to data in data store 110.

UI component 104 is illustratively controlled by other components, servers, or items in data storage system 100 in order to generate user interface displays for users using devices 114, 116, and 118. Devices 114, 116, and 118 are merely provided as examples of various user devices that may be used to interact with system 100. In the illustrated example, device 114 is a mobile device, such as a smart phone; device 116 is a laptop or notebook computer; and device 118 is a desktop computer. It will be noted, however, there can also be user interface components on devices 114, 116, and 118 which generate those user interface displays as well. Further, it will be noted that user interface component 104 can generate the user interface displays itself, or under the control of other items shown in FIG. 1.

The user interface displays illustratively include user input mechanisms that allow the users to control and manipulate data storage system 100, in order to upload, access, share, and manage electronic files stored within data store 110. The user input mechanisms can include a wide variety of different types of user input mechanisms such as links, icons, buttons, drop down menus, text boxes, check boxes, etc. In addition, the user input mechanisms can be actuated by the user in a wide variety of different ways. For example, they can be actuated using touch gestures (when the display is touch sensitive), a hard or soft keyboard or keypad, a point and click device (such as a mouse or trackball), buttons, joysticks, or other actuators, additionally, where data storage provider 100 or one of devices 114, 116, and 118 has speech recognition components, the user input mechanisms can also be actuated by using voice commands.

Access control component 106 may employ an access control list or other suitable structure that includes information that indicates permissions or access rights for each user or group of users that are able to use data storage provider 100. Additionally, access control component 106 may maintain a list of authorized users for each organization or tenant for which data storage system 100 provides data storage services. Accordingly, a list of users within the organization will be maintained by access control component 106, thereby allowing access control component 106 to identify other users (outside of the organization) as any user who is not listed as a member of the particular organization. Additionally, access control component 106 may receive file access requests from various users who follow file sharing links. Access control component 106 may determine if the incoming file access is authorized based on the access control list, and/or information stored in link store 124, which will be described in greater detail below.

Messaging component 108 may include a messaging server or other suitable device or logic that is able to compose and/or send messages to users. Messaging component 108 may include an e-mail server that supports the known Simple Mail Transfer Protocol (SMTP). However, messaging component 108 may also include an instant messaging server (SMS) or any other device or logic that is able to provide messages to users. Further, in embodiments where access to data storage system 100 is provided to one or more of devices 114, 116, and 118 via an application executing upon said devices, messaging component 108 may include code and/or suitable circuitry to surface such messages or notifications within the application executing upon such user devices.

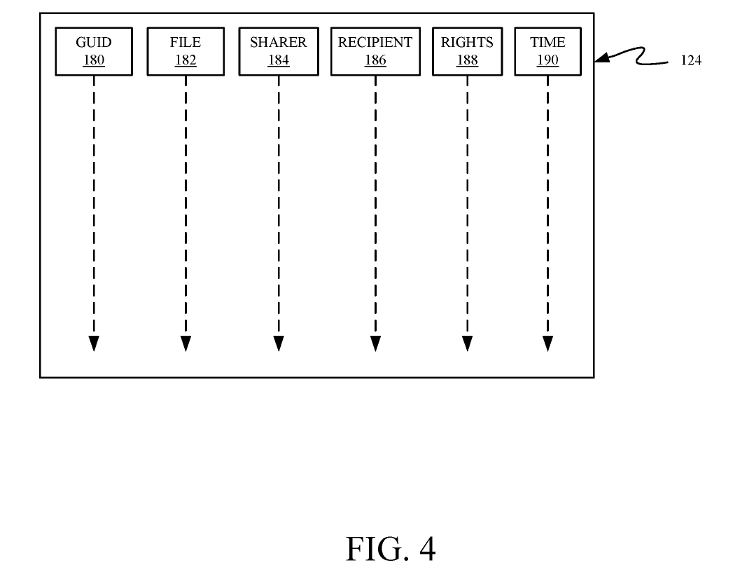

Data store 110 is shown as a single data store that is local to data storage system 100. However, it will be noted that data store 110, in actuality, may be comprised of a number of different data stores, all of which may be local to data storage system 100, some of which may be local to data storage system 100, or all of which may be remote therefrom. Data store 110 illustratively stores a number of electronic files 120 within folders 122. Additionally, data store 110 also includes link store 124 in accordance with one embodiment. Link store 124 will be described in greater detail below with respect to FIG. 4.

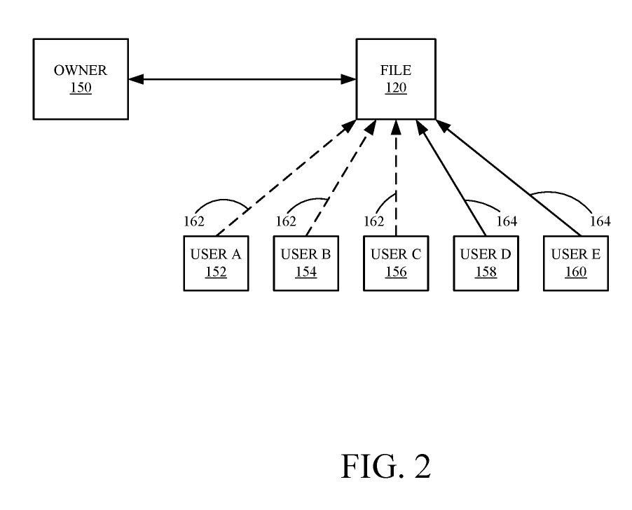

FIG. 2 is a diagrammatic view illustrating file sharing where different links are used to provide different access levels to users, but are otherwise re-used. In the example illustrated in FIG. 2, a first entity, such as owner 150, has created file 120 and uploaded or otherwise stored file 120 in data store 110 of data storage system 100. Then, owner 150 has chosen to share file 120 with a second entity, such as user 152, and allow user 152 to only view, but not change or otherwise edit file 120. When this sharing operation occurs, data storage system 100 generates a link to file 120 that is provided to user 152. This read-only link is provided to user 152 in any suitable way. In one example, an invitation or other electronic communication is provided by messaging component 108. However, the read-only link may be provided to user 152 in other ways as well, such as by manually providing the link to owner 150 who then gives the link to user 152. The read-only link for user 152 to access file 120 is illustrated diagrammatically at dashed line 162. Subsequently, owner 150 may wish to share file 120 with user 154 in a read-only fashion. When owner 150 so shares file 120 with user 154, the exact link 162 is provided to user 154 such as by using an electronic invitation facilitated by messaging component 108. Accordingly, users 152 and 154 access file 120 using the exact same link. Subsequently, user 152 or a user 154 may wish to re-share read access to file 120 and thus provide link 162 to user 156. This can be accomplished by employing a sharing operation supported by data storage system 100, or by providing the link directly to user 156. Regardless, users 152, 154, and 156 use the exact same link that provides read-only access to file 120. A second link, 164 is provided to user 158 when owner 150 chooses to provide read/write access to file 120 for user 158. However, if user 158 wishes to re-share read/write access to file 120, the exact same read/write link 164 is provided to user 160.

As can be seen, multiple users employ the same link based on the type of access that is provided to file 120 regardless of the entity that shared or otherwise provided such access. This system has some limitations. Specifically, if owner 150 wishes to revoke read-access to file 120 by user 152, owner 120 can revoke such access using data storage system 100 relative to link 162. However, as can be appreciated, read-access to file 120 is also revoked with respect to users 154 and 156 since they use the same link. Another limitation is that a particular shared link by an individual user, such as user 154, may be improper or a security threat. Providing link analytics that allow accesses and access patterns to be evaluated based on the sharer would enhance the ability to detect security threats and malicious actors more quickly.

Embodiments described herein generally support improved granularity with respect to links that share electronic documents. Instead of creating one read and/or one edit link per file, embodiments provided herein generally create a unique link for each user that creates the link. This allows the management of individual links as well as improved analytics for each link.

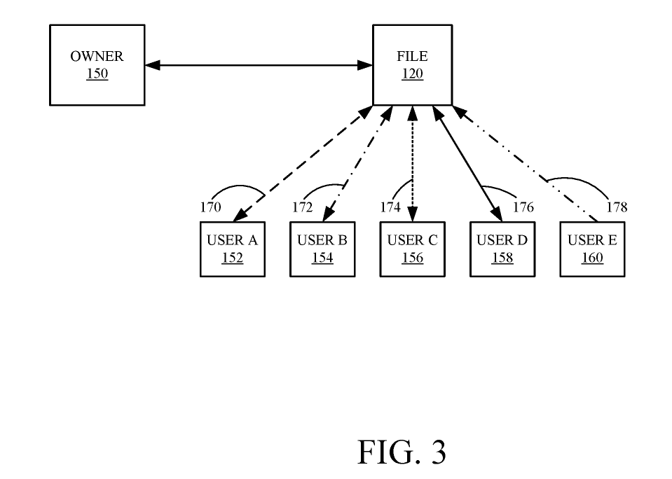

FIG. 3 is a diagrammatic view of multiple users sharing a file in accordance with one embodiment. As shown in FIG. 3, a first entity, such as owner 150, has uploaded file 120 to data storage system 100 and has chosen to provide read-only based access to file 120 for a second entity, such as user 152. When this occurs, data storage system 100 will generate a unique link 170 for user 152. The link can be provided to user 152 in any suitable manner. When user 152 engages the link, user 152 will be able to read but not modify file 120. Subsequently, owner 150 may choose to provide read-only access to file 120 for a third entity, such as user 154. In the example shown in FIG. 3, such read-only access is provided via a second link 172 that is different than first link 170. Thus, it can be seen, that the links can vary based on the recipient of the entity to whom the sharing is provided. Next, user 154 may wish to provide read-only based access to file 120 for a fourth entity, such as user 156. When this occurs, data storage system 100 fashions a third link 174 that is different from first and second links 170, 172. Link 174 is provided to user 156 in any suitable manner, such as by using messaging component 108 or surfacing the link in an application used by user 156. Accordingly, links 172 and 174 are distinct from one another even though they both provide read-only access to file 120. This is because links 172 and 174 were originated by different sharing entities. Specifically, link 172 was originated by owner 150 while link 174 was originated by user 154. Next, owner 150 may wish to provide read/write access to file 120 for a user 158. When this occurs, data storage system 100 fashions link 176 that is provided to user 158 in any suitable manner. User 158 engages the link in order to interact with file 120 using data storage system 100 and can read and write changes to file 120. Subsequently, if user 158 wishes to provide read/write access to file 120 to user 160, data storage system 100 will fashion link 178. Again, link 178 can be provided to user 160 in any suitable manner. Accordingly, in the example illustrated in FIG. 3, all links 170, 172, 174, 176, and 178 are different links. This provides an important feature in that owner 150 can disable and thereby revoke access to file 120 on a per-user basis. Further still, data storage system 100 may facilitate important analytics that may detect malicious activity more quickly. For example, if link 178 has substantially more activity (i.e., a large number of accesses from a variety of domains or IP addresses) owner 150 may investigate such activity further and decide that link 178 should be cancelled thereby revoking access to file 120 by user 160. Accordingly, the embodiment illustrated with respect to FIG. 3 allows different users to share the same file but with essentially a different audience and thus with different permissions. Further still, owner 150 or a responsible party can set sharing policies depending on who is sharing documents and can analyze opening patterns for links independently of each other and be able to know who created each link.

FIG. 4 is a diagrammatic view of link store 124 in accordance with one embodiment. Link store 124 is used to store information with respect to each and every access link created by data storage system 100 for allowing users to access files. Each link represents a row in the table shown in FIG. 4. A first column stores a globally unique identifier (GUID) that is generated and assigned to each link. Accordingly, each individual link is entirely unique within data storage system 100. The GUID column is indicated at reference numeral 180. Additionally, each link includes an identification of the electronic file to which it pertains. This is indicated at column 182. At column 184, each link stored in link store 124 includes an indication of the entity that generated the link. At column 186, each link includes an indication of the recipient of the link. Column 188 provides an indication of the rights provided by the access link is stored. This information can include read, write, delete, etc. Further, these rights can be indicated in any suitable fashion, such as flags or bits in a byte code. Finally, in the example shown in FIG. 4, each link includes a timestamp 190 indicating when the link was created.

When a link is created, data storage system 100 obtains information regarding the sharer as well as the recipient and assigns a globally unique identifier to the link. Moreover, the recipient need not be a single recipient, but may in fact be a potential recipient scope, such as “anyone in the world” or “anyone in my company.” In this way, when a user proceeds to share a file, such as a document, data storage system 100 can query or otherwise access link store 124 and provide a listing of previously-created links created by the user. If the user has not created a link for the particular file, then the user can create a new link that is added to link store 124 having its own GUID, which can be tracked independently.

As set forth above, users can create individual access links to content stored in data storage system 100 and those links are unique. This allows a new link to be created per user who creates the link. In this way, there can be several links to the same file with the same permission level. In one example, users will not see links created by others, but instead must create their own links. This helps facilitate link isolation and will allow owners and responsible parties, such as administrators, to see link usage patterns for individual links. For example, the responsible party may determine that one link was opened three times while a different link was opened 340 times. This may prompt the responsible party to investigate the activities surrounding the link that was opened 340 times and perhaps disable that link. When the link is disabled, the other links are not necessarily disabled. This minimizes the impact on other users. Further, links can have different policies applied to them based on which user generated them. For example, a project manager may have the ability to generate links that can be accessed for long periods of time and for many uses. Conversely, a link shared by an external user of the organization may have a policy that it exists for a very short period of time and may be only opened one or two times. This is merely an example of different policies for sharing links based on the users who create the links.

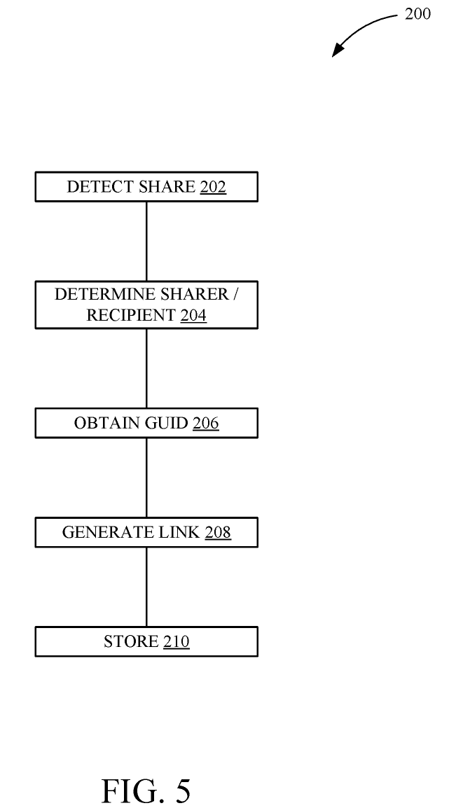

FIG. 5 is a flow diagram of a method of sharing an electronic file in accordance with one embodiment. Method 200 begins at block 202 where a sharing operation is detected. This may be accomplished by a user selecting a “share” user interface element when interacting with a particular file in data storage system 100. However, other techniques can be used as well. In response to the detected sharing operation, data storage system 100 provides a user interface to the user wishing to share the electronic file. The user interacts with the user interface and provides recipient information to data storage system 100. Additionally, since the user is logged in or otherwise accessing data storage system 100, data storage system 100 knows the identity of the person or entity wishing to share the electronic file. Accordingly, at block 204, data storage system 100 determines the sharer and recipient of the electronic file. Next, at block 206, data storage system 100 obtains a globally unique identifier for the link that will be provided to the recipient. Once method 200 has obtained the globally unique identifier, the link is generated at block 208. The link may simply include the globally unique identifier, or it may be some function of the globally unique identifier. Regardless, when data storage system 100 receives the link in a file access request from the recipient, the GUID can be referenced to link store 124 to verify the sharer, recipient, rights, file, and time. Moreover, data storage system 100 can verify that it is the recipient that is using the link to access the appropriate file in the appropriate way. Finally, at block 210, the link is saved or otherwise persisted. In one example, the link is saved as a new record in link store 124.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

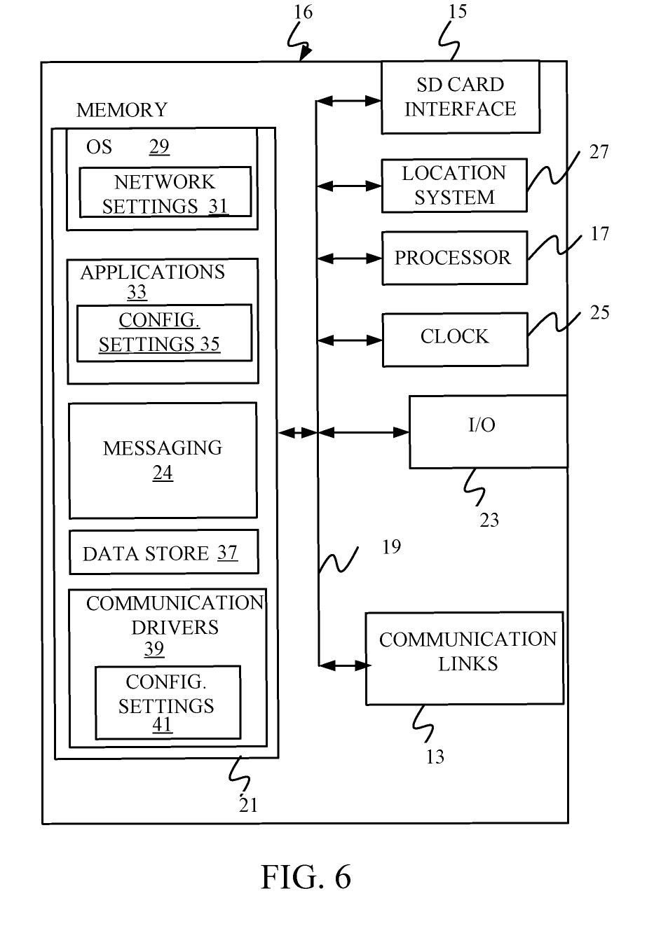

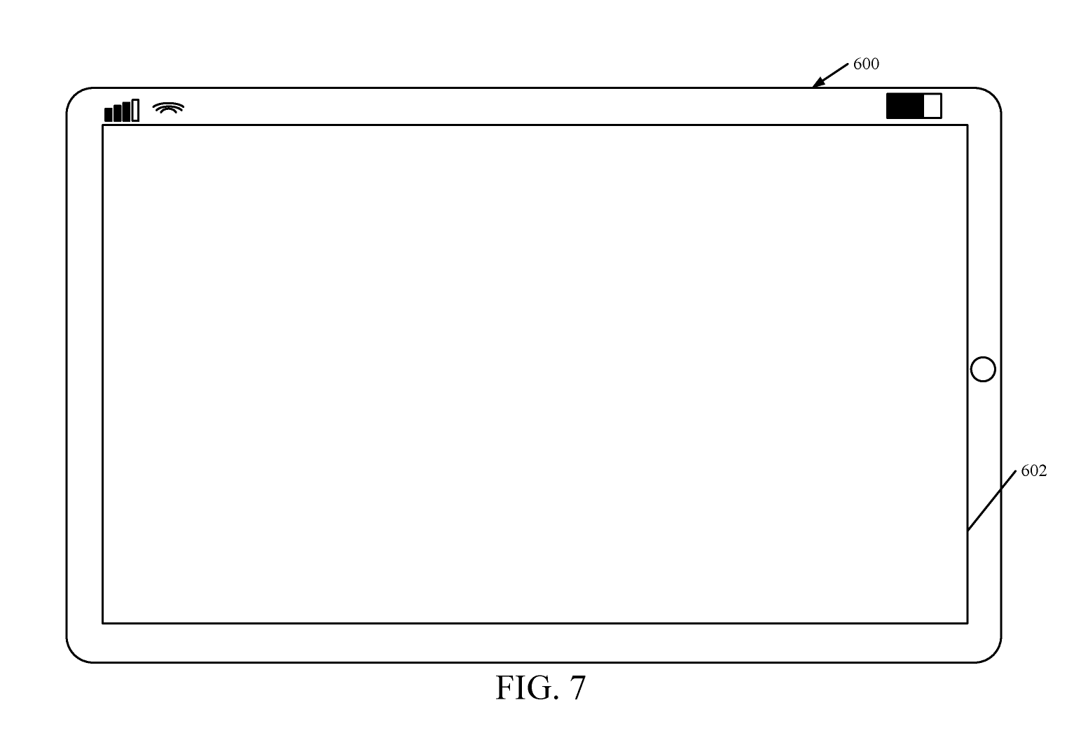

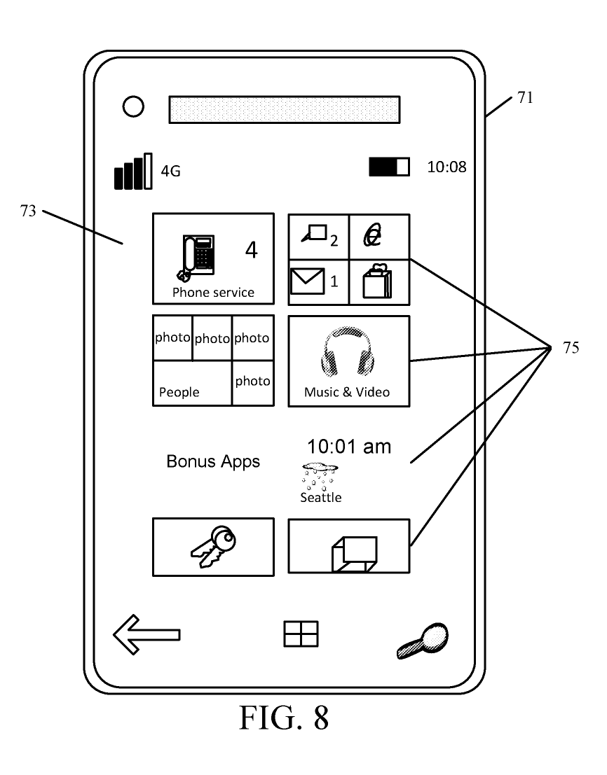

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of data storage system 100 or that interacts with data storage system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with display screen 602, which can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 illustrates a user device being a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

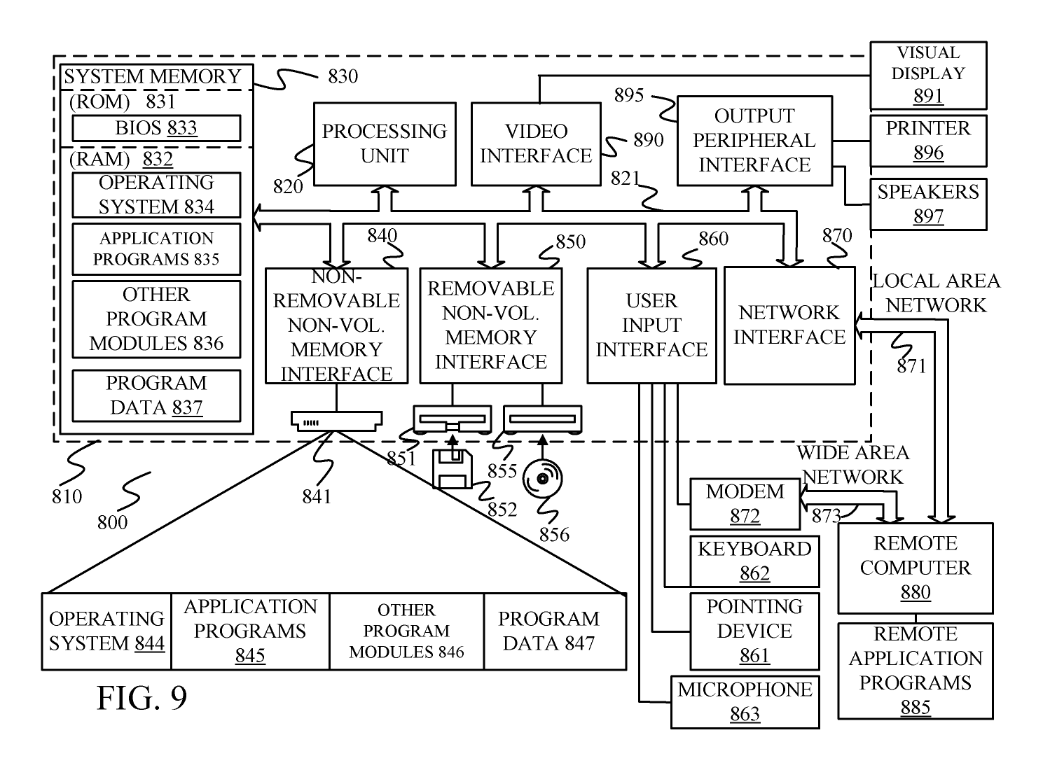

FIG. 9 is one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory, programs and components described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is an electronic file sharing system that includes a data store, a processor, and memory. The memory is coupled to the processor and stores instructions that when executed by the processor, provide electronic file storage relative to the data store. The processor is configured to detect a first sharing operation from a first entity to share a selected electronic file with a second entity to allow the second entity to interact with the selected electronic file in a way set by the first entity. The processor is further configured to generate a first sharing link for the second entity to access the selected electronic file in the way set by the first entity. The processor is also configured to detect a second sharing operation from the second entity to share the selected electronic file with a third entity in the way set by the first entity and to generate a second sharing link for the third entity to access the selected electronic file in the way set by the first entity. The first sharing link is different than the second sharing link.

Example 2 is the electronic file sharing system of any or all previous examples wherein the way set by the first entity is read-only access.

Example 3 is the electronic file sharing system of any or all previous examples wherein the way set by the first entity is read/write access.

Example 4 is the electronic file sharing system of any or all previous examples wherein the processor is configured to detect a third sharing operation from the first entity to share the selected electronic file with a fourth entity in the way set by the first entity and wherein the processor is configured to generate a third sharing link for the fourth entity to access the selected electronic file in the way set by the first entity and wherein the first sharing link is different than the third sharing link.

Example 5 is the electronic file sharing system of any or all previous examples wherein the processor is configured to detect the first sharing operation with a user interface component through which the first user interacts with the electronic file sharing system over a network.

Example 6 is the electronic file sharing system of any or all previous examples wherein the processor is configured to store information related to each sharing link in a link store.

Example 7 is the electronic file sharing system of any or all previous examples wherein information related to each link includes information indicative of the entity that generated the sharing operation and the entity with which the electronic file is shared.

Example 8 is the electronic file sharing system of any or all previous examples wherein information related to each link includes at least one access right for the electronic file.

Example 9 is the electronic file sharing system of any or all previous examples wherein information related to each link includes a timestamp indicative of a time at which the sharing link was generated.

Example 10 is the electronic file sharing system of any or all previous examples wherein the processor is configured to generate each sharing link based on a respective globally unique identifier (GUID) for each respective link.

Example 11 is an electronic file sharing system that includes a data store, a processor, and memory coupled to the processor and storing instructions that when executed by the processor, provide electronic file storage relative to the data store. The processor is configured to detect a first sharing operation from a first entity to share a selected electronic file with a second entity to allow the second entity to interact with the selected electronic file in a way set by the first entity. The processor is also configured to obtain a unique identifier and generate a first sharing link for the second entity to access the selected electronic file in the way set by the first entity using the unique identifier. The processor is configured to store information related to the link in a link store.

Example 12 is the electronic file sharing system of any or all previous examples wherein the information related to the link includes the selected electronic file, the unique identifier, the first entity and the second entity.

Example 13 is the electronic file sharing system of any or all previous examples wherein the information related to the link includes an indication of access rights that define a way in which the second entity may interact with the selected electronic file.

Example 14 is the electronic file sharing system of any or all previous examples wherein the information related to the link includes a timestamp generated when the link was created.

Example 15 is the electronic file sharing system of any or all previous examples wherein the link store is a part of the electronic file sharing system.

Example 16 is the electronic file sharing system of any or all previous examples and further comprising an access control component configured to receive a file access request based on the second entity using the first sharing link and access the link store to verify that the file access request is from the authorized entity associated with the link.

Example 17 is a method of sharing electronic files that includes storing an electronic file in an electronic file sharing system. A request is received to share the electronic file from a first entity. A first sharing link is responsively generated to share the electronic file with a second entity to allow the second entity to interact with the file in a set manner. A request to share the electronic file is received from a third entity. A second sharing link is responsively generated to share the electronic file with a fourth entity to allow the fourth entity to interact with the file in the set manner. The first and second sharing links are different.

Example 18 is the method of sharing electronic files of any or all of the previous examples wherein the set manner is read-only access.

Example 19 is the method of sharing electronic files of any or all of the previous examples and further comprising receiving a link revocation from a responsible party that disables access to the electronic file with the first sharing link, but allows access to the electronic file with the second sharing link.

Example 20 is the method of sharing electronic files of any or all of the previous examples wherein each sharing link is generated based on a different unique identifier.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electronic file sharing system comprising:
a data store;
a processor;
memory coupled to the processor and storing instructions that when executed by the processor, provide electronic file storage relative to the data store;
the processor being configured to detect a first sharing operation from a first entity to share a selected electronic file with a second entity to allow the second entity to interact with the selected electronic file in a way set by the first entity and wherein the processor is configured to generate a first sharing link for the second entity to access the selected electronic file in the way set by the first entity;
the processor being configured to detect a second sharing operation from an entity other than the first entity to share the selected electronic file with a third entity in the way set by the first entity and wherein the processor is configured to generate a second sharing link for the third entity to access the selected electronic file in the way set by the first entity; and
wherein the first sharing link is different than the second sharing link.

2. The electronic file sharing system of claim 1, wherein the way set by the first entity is read-only access.

3. The electronic file sharing system of claim 1, wherein the way set by the first entity is read/write access.

4. The electronic file sharing system of claim 1, wherein the processor is configured to detect a third sharing operation from the first entity to share the selected electronic file with a fourth entity in the way set by the first entity and wherein the processor is configured to generate a third sharing link for the fourth entity to access the selected electronic file in the way set by the first entity and wherein the first sharing link is different than the third sharing link.

5. The electronic file sharing system of claim 1, wherein the processor is configured to detect the first sharing operation with a user interface component through which the first user interacts with the electronic file sharing system over a network.

6. The electronic file sharing system of claim 5, wherein the processor is configured to store information related to each sharing link in a link store.

7. The electronic file sharing system of claim 6, wherein information related to each link includes information indicative of the entity that generated the sharing operation and the entity with which the electronic file is shared.

8. The electronic file sharing system of claim 6, wherein information related to each link includes at least one access right for the electronic file.

9. The electronic file sharing system of claim 8, wherein information related to each link includes a timestamp indicative of a time at which the sharing link was generated.

10. The electronic file sharing system of claim 1, wherein the processor is configured to generate each sharing link based on a respective globally unique identifier (GUID) for each respective link.

11. An electronic file sharing system comprising:
a data store;
a processor;
memory coupled to the processor and storing instructions that when executed by the processor, provide electronic file storage relative to the data store;
the processor being configured to detect a first sharing operation from a first entity to share a selected electronic file with a second entity to allow the second entity to interact with the selected electronic file in a way set by the first entity and wherein the processor is configured to obtain a unique identifier and generate a first sharing link for the second entity to access the selected electronic file in the way set by the first entity using the unique identifier; and
wherein the processor is configured to store information related to the link in a link store.

12. The electronic file sharing system of claim 11, wherein the information related to the link includes the selected electronic file, the unique identifier, the first entity and the second entity.

13. The electronic file sharing system of claim 12, wherein the information related to the link includes an indication of access rights that define a way in which the second entity may interact with the selected electronic file.

14. The electronic file sharing system of claim 12, wherein the information related to the link includes a timestamp generated when the link was created.

15. The electronic file sharing system of claim 11, wherein the link store is a part of the electronic file sharing system.

16. The electronic file sharing system of claim 11, and further comprising an access control component configured to receive a file access request based on the second entity using the first sharing link and access the link store to verify that the file access request is from the authorized entity associated with the link.

17. A method of sharing electronic files, the method comprising:
storing an electronic file in an electronic file sharing system;
receiving a request to share the electronic file from a first entity and responsively generating a first sharing link to share the electronic file with a second entity to allow the second entity to interact with the file in a set manner;
receiving a request to share the electronic file from a third entity and responsively generating a second sharing link to share the electronic file with a fourth entity to allow the fourth entity to interact with the file in the set manner; and
wherein the first and second sharing links are different.

18. The method of claim 17, wherein the set manner is read-only access.

19. The method of claim 17, and further comprising receiving a link revocation from a responsible party that disables access to the electronic file with the first sharing link, but allows access to the electronic file with the second sharing link.

20. The method of claim 17, wherein each sharing link is generated based on a different unique identifier.
